(19) United States
(12) Patent Application Publication
(10) Pub. No.: US 2014/0081877 A1
(43) Pub. Date: Mar. 20, 2014

(54) METHODS AND SYSTEMS FOR CALCULATING ENERGY CREDITS FOR MATERIALS

(71) Applicant: EMPIRE TECHNOLOGY DEVELOPMENT LLC, Wilmington, DE (US)

(72) Inventors: Timothy Londergan, Seattle, WA (US); Feng Wan, Issaquah, WA (US); Scott Needham, Mangerton (AU); James Wang, Beijing (CN)

(21) Appl. No.: 13/810,874

(22) PCT Filed: Sep. 20, 2012
(86) PCT No.: PCT/US12/56339

§ 371 Date: Jan. 17, 2013

(51) Int. Cl. G06Q 30/00

(52) U.S. Cl. CPC G06Q 30/018
USPC 705/317

(57) ABSTRACT

Methods and systems for providing an energy credit for a material are disclosed. A material may be provided. A total carbon content in the material is determined to provide a total carbon count. The total carbon count is associated with an intrinsic energy score for the material that is based on the total carbon count. An acquired character energy score based on an environmental cost of an acquired character of the material is determined. An energy credit for the material is determined based on the intrinsic energy score and the acquired character energy score.

### BACKGROUND

Materials such as polymers and metals can be found in every aspect of modern life, from consumer goods, packaging materials, furniture, electronics, cars, airplanes, machinery, buildings, rockets, weaponry, and satellites. Currently, products are produced from two types of materials, recycled materials and virgin materials.

Virgin materials are materials that have not previously been used or consumed, or subjected to processing other than for its original production. In comparison, recycled materials are materials that are recovered from used material or waste.

It is believed that, in general, more energy is required to extract, process, and transport virgin materials than recycled materials. Higher energy consumption equals greater emissions of greenhouse gasses. For example, when producing materials from virgin steel, copper, glass or paper, net carbon emissions are four to five times higher than if produced from recycled materials; for aluminum, there are 40 times higher. Similarly, the process of extracting and processing petroleum to make plastic uses 4 to 8 times as much energy as making the same products from recycled plastics. Recycling is a process for processing used materials or waste into recycled materials in order to prevent the waste of potentially useful materials, to reduce energy usage from the production of new materials, to reduce air pollution caused by the incineration of waste materials, and to reduce water pollution as a result of landfilling. Recycling can reduce the need for conventional waste disposal and lower greenhouse gas emissions as compared with virgin production of new materials.

Recycling efforts have gradually gained traction at city, state and federal levels. For example, many jurisdictions provide recycling bins to encourage residents to increase recycling and to reduce waste production. However, if additional incentives were provided to consumers, it would further encourage consumers to recycle their used recyclable materials.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a method of providing an energy credit for a material may include determining a total carbon content in the material to provide a total carbon count, associating the total carbon count with an intrinsic energy score for the material based on the total carbon count, determining an acquired character energy score based on an acquired character of the material or an environmental cost of the acquired character, and determining an energy credit for the material based on the intrinsic energy score and the acquired character energy score.

In an embodiment, a system for providing an energy credit for a material may include a processing device and a non-transitory computer-readable storage medium in communication with the processing device. The computer-readable storage medium contains one or more programming instructions that, when executed, cause the processing device to determine a total carbon content in a material to provide a total carbon count, associate the total carbon count with an intrinsic energy score for the material that is proportional to the total carbon count, determine an acquired character energy score based on an acquired character of the material that is proportional to an environmental cost of the acquired character, and determine an energy credit for the material based on the intrinsic energy score and the acquired character energy score.

The material may be a virgin material, a recycled material, or a combination thereof.

### BRIEF DESCRIPTION OF THE FIGURES

FIG. 1 depicts a flow diagram of an illustrative method of providing an energy credit for a material according to an embodiment.

FIG. 2 depicts a block diagram of illustrative internal hardware that may be used to contain or implement program instructions according to an embodiment.

### DETAILED DESCRIPTION

The following terms shall have, for the purposes of this application, the respective meanings set forth below.

An “acquired character” refers to a state of a material after processing. For example, the acquired character may be associated with an environmental cost of the material.

An “acquired character energy score” refers to a value assigned to a material based on the acquired character of the material. The acquired character energy score may be determined based on an environmental cost associated with the material.

An “environmental cost” refers to an economic impact caused by the production of a material. The environmental cost for a material may include costs incurred as a result of energy consumption in extracting, producing, transporting and/or maintaining the material and/or costs associated with the environmental impact of the material resulting from pollution as a result of producing the chemical compounds, such as monomers, polymers, and/or precursors in the material.

An “intrinsic energy score” refers to an economic value associated with the innate value of the material. For example, the intrinsic energy score may include a measure of the total carbon count in a material. The intrinsic energy score may include a plurality of values, such as a carbon value, a hydrogen value, an oxygen value, a nitrogen value, a sulphur value, other values, or a combination of one or more of such values.

An “energy credit” refers to a quantitative value provided to an entity for a material. An energy credit may correspond to a cash refund or reward, a tax credit, an account credit, a carbon credit, a recycling credit, or any other quantitative value provided to an individual or manufacturer, distributor or other corporate entity for a material. For example, a recycling credit may correspond to a cash refund or reward, a tax credit, or any other incentive provided to an individual or manufacturer, distributor, or other corporate entity for recycling a material.

One problem with conventional manufacturing and recycling processes is that costs associated with a virgin material or a recycled material are not considered when determining a potential value of the material, for example, for virgin material, an energy value, and for recycled material, a recycled value. As such, a need exists for a technology that is capable of valuing materials, including virgin materials and/or recycled materials, consistently. Furthermore, a need exists for a valuation system that encourages recycling behavior.

This disclosure identifies methods and systems for providing an energy credit for a material. In particular, this disclosure identifies methods and systems for providing an energy credit based on a value of a material and costs associated with producing the material, such as environmental costs.

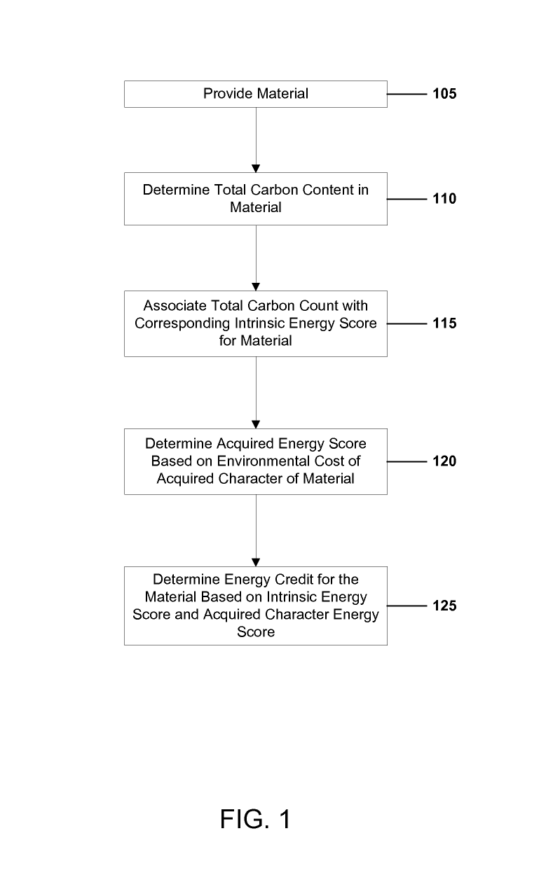

FIG. 1 depicts a flow diagram of an illustrative method of providing an energy credit for a material according to an embodiment. As shown in FIG. 1, a material may be provided 105. The material may be any material, including a virgin material, or a recycled material that is recycled in order to reuse the material. The virgin material may be manufactured using any manufacturing process. The recycled material may be recycled using any recycling techniques.

Two characters may be assigned to a material: an intrinsic character and an acquired character. The intrinsic character is associated with the innate value of the material. The parameters that affect the intrinsic character of the material may include, without limitation, the total carbon count in the material. In an embodiment, element analysis technology may be used to obtain a total carbon count. In an embodiment, an element analysis may be carried out on a sample of the material to provide element composition values of the sample. The element composition values may include a plurality of values, such as a carbon value, a hydrogen value, an oxygen value, a nitrogen value, a sulphur value, other values, or a combination of one or more of these values.

For example, a total carbon content in the material may be determined 110 to provide a total carbon count. In an embodiment, the total carbon content may include a weight of carbon in the material. In an alternate embodiment, the total carbon content may include a volume of carbon in the material. In another embodiment, the total carbon content may include a number of moles of carbon in the material. In yet another embodiment, the total carbon content may include a total number of carbon atoms in the material. In yet other embodiments, combinations of the above-listed or other similar measures may be used to determine the total carbon content.

In an embodiment, for a recycled material, the total carbon content in the recycled material may be determined 110 by homogenizing the recycled material to provide a homogenized recycled material having a total weight, w. A weight percentage of carbon in the homogenized recycled material, p, may be identified. In an embodiment, the total carbon content in the recycled material may be determined by the product of the total weight and the weight percentage of carbon in the homogenized recycled material (i.e., total carbon content=w*p). In an alternate embodiment, the total carbon content in the recycled material may be determined by the following formula:

$$total carbon content = \frac{w * p}{molecular weight of carbon} .$$

In an alternate embodiment, for a recycled material, the total carbon content in the recycled material may be determined 110 by homogenizing the recycled material to provide a homogenized recycled material having a total volume, v. A volume percentage of carbon in the homogenized recycled material, r, may be identified. In an embodiment, identifying a volume percentage of carbon in the homogenized recycled material may include analyzing a portion of the homogenized recycled material to determine the volume percentage of carbon in the portion. The total carbon content in the recycled material may be determined by the product of the total volume and the volume percentage of carbon in the homogenized recycled material (i.e., total carbon content=v*r).

In some embodiments, the above recycled material may be heterogeneous due to the nature of the recycled material or impurity of the recycled material. Among other goals, the homogenization step provides quality and content consistency to the material and therefore allows a consistent valuation of the total carbon content.

In some embodiments, the recycled material may be analyzed to provide a chemical composition of the recycled material. One or more of a plurality of chemical analysis techniques may be used to analyze the recycling material and provide chemical composition information. For example, analyzing the recycled material to provide a chemical composition may include using one or more of analytical analysis, combustion analysis, elemental analysis, gas chromatography, mass spectroscopy, infrared spectroscopy, liquid chromatography, magnetic resonance, gravimetry, optical atomic spectroscopy, sodium fusion test, Schoniger oxidation, and the like. The weight percentage of carbon in the homogenized recycled material, p, may be identified based on the chemical composition of the recycled material. For example, an elemental analysis may provide that the mass fraction of carbon in a homogenized material sample is x percent, which equals to the weight percentage of the carbon in the homogenized recycled material. In some embodiments, a virgin material may be subjected to the above steps to provide a total carbon content of the virgin material. When the virgin material is homogenous and has a known chemical composition or chemical formula, the total carbon content may be derived without the homogenizing step. In one embodiment, the weight percentage of carbon, p, may be determined by the total molecular weight of carbon divided by the total molecular weight of the virgin material. For example, a virgin material may have a molecule formula of CₘHₙOₓ. The weight percentage of carbon, p, may be determined by the following formula:

$$\frac{MolecularWeightOfCarbon * m}{\begin{matrix}MolecularWeightOfCarbon * m + \\ MolecularWeightOfHydrogen * n + \\ MolecularWeightOfOxygen * x\end{matrix}}$$

Recycled materials within the scope of this disclosure may include any materials from a recycled process. Virgin materials within the scope of this disclosure may include, without limitation, any commodity materials or specialty materials.

Example materials include, without limitation, petroleum-based polymers, biomass-based polymers, textile, glass, and metal. In some embodiments, the material may include plastics, resins, glass, paper, metal, wood, plywood, textiles, or a combination thereof. In some embodiments, the materials may include cellulose or derivatives such as cellulose nitrate, cellulose acetate, and rayon, starch, rubber (polyisoprene), lignin or derivatives, protein based polymers such as keratin, collagen, gelatin, chitosan and silk, polysaccharides, polyimides, polyamides, polycarbonates, polyesters, nylon, epoxy resin, aramide, polymercarbamates, polyacrylate, latex, or a combination thereof. In some embodiments, the materials may include polyethylene, terephthalate, high density polyethylene, low density polyethylene, polypropylene, polystyrene, polylatic acid, silicone, polyurethane, polyvinyl chloride, polyacrylonitrle, poly(styrene-butadiene-styrene), poly(methyl methacrylate), or a combination thereof. In some embodiments, the materials may include monomers, chemical intermediates, and precursors.

Additional and/or alternate methods for determining 110 the total carbon content in material, virgin or recycled, may be performed within the scope of this disclosure.

The total carbon count may be associated 115 with a corresponding intrinsic energy score for the material. The intrinsic energy score may be based on the total carbon count. The intrinsic energy score may be a representation of the intrinsic character of the material.

An acquired character energy score may be determined 120 based on an environmental cost of an acquired character of the material. The acquired character is associated with the environmental cost of the material. The environmental cost for a material may include costs incurred as a result of energy consumption in producing, transporting and/or maintaining the material and/or costs associated with the environmental impact of the material resulting from pollution as a result of producing the chemical compounds in the material.

An energy credit may be determined 125 for the material based on the intrinsic energy score and the acquired character energy score. In an embodiment, determining 125 the energy credit for the material may include subtracting the acquired character energy score from the intrinsic energy score.

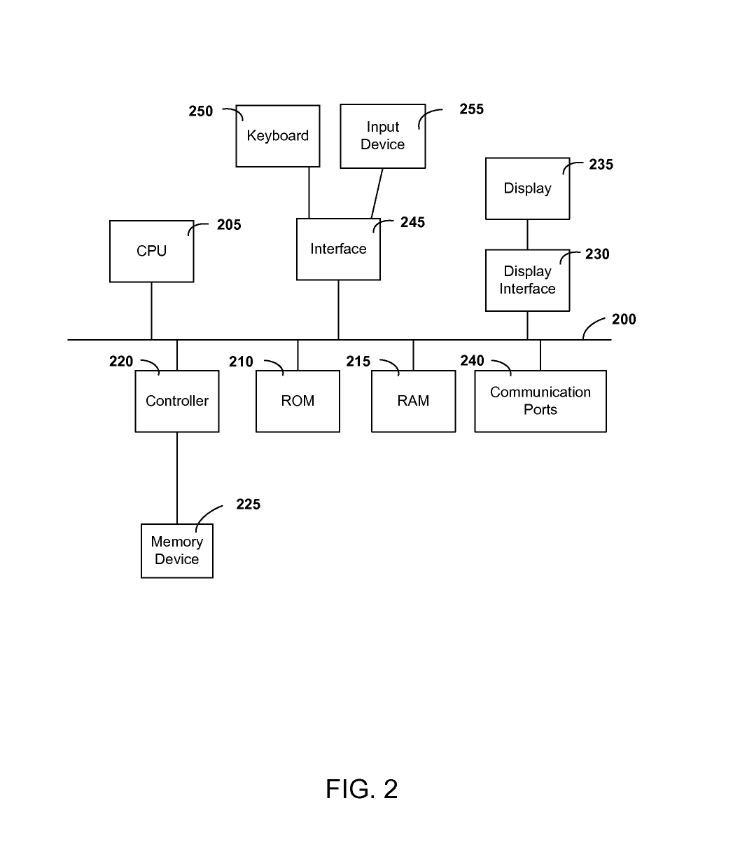

FIG. 2 depicts a block diagram of illustrative internal hardware that may be used to contain or implement program instructions, such as the process steps discussed above in reference to FIG. 1, according to an embodiment. A bus 200 serves as the main information highway interconnecting the other illustrated components of the hardware. CPU 205 is the central processing unit of the system, performing calculations and logic operations required to execute a program. CPU 205, alone or in conjunction with one or more of the other elements disclosed in FIG. 2, is an exemplary processing device, computing device or processor as such terms are used within this disclosure. Read only memory (ROM) 210 and random access memory (RAM) 215 constitute exemplary memory devices (i.e., processor-readable non-transitory storage media).

A controller 220 interfaces with one or more optional memory devices 225 to the system bus 200. These memory devices 225 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 210 and/or the RAM 215. Optionally, the program instructions may be stored on a tangible computer readable medium such as a compact disk, a digital disk, flash memory, a memory card, a USB drive, an optical disc storage medium, such as a Blu-ray™ disc, and/or other non-transitory storage media.

An optional display interface 230 may permit information from the bus 200 to be displayed on the display 235 in audio, visual, graphic or alphanumeric format. Communication with external devices, such as a print device, may occur using various communication ports 240. An exemplary communication port 240 may be attached to a communications network, such as the Internet or an intranet.

The hardware may also include an interface 245 which allows for receipt of data from input devices such as a keyboard 250 or other input device 255 such as a mouse, a joystick, a touch screen, a remote control, a pointing device, a video input device and/or an audio input device. In an embodiment, chemical composition information may be received from one or more input devices 255, such as a gas chromatograph, an elemental analyzer, a mass spectrometer, an infrared spectrometer, a liquid chromatograph, a nuclear magnetic resonance imager and/or the like.

### EXAMPLES

### Example 1

### Weight Percentage Intrinsic Energy Score Determination

A plastic material is brought to a recycling facility for recycling. The recycled material is homogenized into pieces of similar size and composition. An intrinsic energy score for the recycled material is determined based on the total weight of the homogenized material, such as 600,000 kilograms of plastic material. The weight percentage of each component in the recycled material is determined. For example, using an elemental analysis, the homogenized plastic material is found to include about 62.5% carbon, about 33.3% oxygen and about 4.2% hydrogen. As such, the intrinsic energy score for 600,000 kilograms of the plastic material would be based on about 375,000 kilograms of carbon, about 200,000 kilograms of oxygen and/or about 25,000 kilograms of hydrogen. In addition, an acquired character energy score for the recycled material is determined based on the chemical composition of the material and the amount of pollution that is estimated to be produced as a result of manufacturing the material. A chemical composition for the homogenized material is determined using a mass spectrometer on a portion of the material. The energy credit is determined by subtracting the acquired character energy score from the intrinsic energy score for the recycled material.

### Example 2

### Volume Percentage Energy Credit Determination

A plastic material is brought to a recycling facility for recycling. The recycled material is homogenized into pieces of similar size and composition. An intrinsic energy score for the recycled material is determined based on the total volume of the homogenized material, such as 60,000 cubic meters of polyethylene terephthalate (PET), and the percentage of each component of the recycled material, such as about 62.5% carbon, about 33.3% oxygen and about 4.2% hydrogen for PET. As such, the intrinsic energy score for 60,000 cubic meters of PET would be based on about 37,500 cubic meters of carbon, about 20,000 cubic meters of oxygen and/or about 2,500 cubic meters of hydrogen. In addition, an acquired character energy score for the recycled material is determined based on the chemical composition of the material and the amount of pollution that is estimated to be produced as a result of manufacturing the material. A chemical composition for the homogenized material is determined using a gas chromatography on a portion of the material. More particularly, the intrinsic energy score for clear PET based on the chemical components of PET is approximately ten cents per kilogram ($0.10/kg). The acquired character energy score for clear PET may be estimated to be eight cents per kilogram ($0.08/kg) based on the environmental impact from producing and transporting the clear PET. The energy credit is determined by subtracting the acquired character energy score from the intrinsic energy score for the PET. The density of PET is 1400 kilograms per cubic meter. As such, the energy credit for 60,000 cubic meters of clear PET is $0.02*1400 kg/m³*60000 m³=$1.68 M.

### Example 3

### System for Providing an Energy Credit for a Recycled Material

A system for providing an energy credit is located at a recycling facility. The system includes a processor and a memory device that includes instructions for determining the energy credit. The system receives information from a user via an input device regarding the recycling material for which the energy credit is provided. The information includes the type of material being recycled. A scale identifies a total weight of the recycled material. Based on the total weight and type of the material being recycled, the system will provide an energy credit. The energy credit is further based on an intrinsic energy score for the recycled material and the acquired energy credit score for the recycled material, which is stored in the memory device. An exemplary calculation is shown above in reference to Example 2.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of providing an energy credit for a material, the method comprising:
determining a total carbon content in the material to provide a total carbon count;
associating the total carbon count with an intrinsic energy score for the material, wherein the intrinsic energy score is based on the total carbon count;
determining an acquired character energy score based on an environmental cost of an acquired character of the material; and
determining an energy credit for the material based on the intrinsic energy score and the acquired character energy score.

2. The method of claim 1, wherein the total carbon content comprises a weight of carbon in the material, a volume of carbon in the material, a number of moles of carbon in the material, a total number of carbon atoms in the material, or a combination thereof.

3. The method of claim 1, wherein determining the total carbon content in the material comprises:
homogenizing the material to provide a homogenized material having a total weight (w);
identifying a weight percentage of carbon (p) in the homogenized material; and
determining the total carbon content in the material using one of the following formulae:
$$total carbon content = w * p , \\ and$$
$$total carbon content = \frac{w * p}{molecular weight of carbon} .$$

4. The method of claim 1, wherein determining the total carbon content in the material comprises:
homogenizing the material to provide a homogenized material having a total volume (v);
identifying a volume percentage of carbon (r) in the homogenized material; and
determining the total carbon content in the material using the following formula:
total carbon content=v*r.

5. The method of claim 4, wherein identifying a volume percentage of carbon in the homogenized material comprises analyzing a portion of the homogenized material to determine the volume percentage of carbon in the portion.

6. The method of claim 1, wherein the environmental cost of the acquired character comprises the energy consumed during transportation of the material.

7. The method of claim 1, wherein the environmental cost of the acquired character comprises an amount of energy consumed to produce the chemical composition of the material.

8. The method of claim 1, wherein the environmental cost of the acquired character comprises an amount of environmental pollution resulting from producing the chemical composition of the material.

9. The method of claim 1, wherein determining an energy credit for the material comprises subtracting the acquired character energy score from the intrinsic energy score to provide the energy credit for the material.

10. The method of claim 1, further comprising:
analyzing the material to provide a chemical composition of the material.

11. The method of claim 10, wherein analyzing the material to provide a chemical composition comprises using one or more of the following to determine the chemical composition of the material: elemental analysis, gas chromatography, mass spectroscopy, infrared spectroscopy, liquid chromatography, and nuclear magnetic resonance.

12. The method of claim 1, wherein the material is a virgin material.

13. The method of claim 1, wherein the material is a recycled material.

14. A system for providing an energy credit for a material, the system comprising:
a processing device; and
a non-transitory computer-readable storage medium in communication with the processing device, wherein the computer-readable storage medium contains one or more programming instructions that, when executed, cause the processing device to:
determine a total carbon content in a material to provide a total carbon count,
associate the total carbon count with an intrinsic energy score for the material, wherein the intrinsic energy score is proportional to the total carbon count,
determine an acquired character energy score based on an acquired character of the material, wherein the acquired character energy score is proportional to an environmental cost of the acquired character, and
determine an energy credit for the material based on the intrinsic energy score and the acquired character energy score.

15. The system of claim 14, wherein the total carbon content comprises a weight of carbon in the material, a volume of carbon in the material, a number of moles of carbon in the material, a total number of carbon atoms in the material, or a combination thereof.

16. The system of claim 14, wherein the one or more programming instructions that, when executed, cause the processing device to determine the total carbon content in the material comprise one or more programming instructions that, when executed, cause the processing device to:
identify a weight percentage of carbon (p) in a homogenized material having a total weight (w); and
determine the total carbon content in the material using one of the following formulae:
$$total carbon content = w * p , \\ and$$
$$total carbon content = \frac{w * p}{molecular weight of carbon} .$$

17. The system of claim 14, wherein the one or more programming instructions that, when executed, cause the processing device to determine the total carbon content in the material comprise one or more programming instructions that, when executed, cause the processing device to:
identifying a volume percentage of carbon (r) in a homogenized material having a total volume (v); and
determining the total carbon content in the material using the following formula:
total carbon content=v*r.

18. The system of claim 17, wherein the one or more programming instructions that, when executed, cause the processing device to identify a volume percentage of carbon in the homogenized material comprise one or more programming instructions that, when executed cause the processing device to analyze a portion of the homogenized material to determine the volume percentage of carbon in the portion.

19. The system of claim 14, wherein the environmental cost of the acquired character comprises the energy consumed during transportation of the material.

20. The system of claim 14, wherein the environmental cost of the acquired character comprises an amount of energy consumed to produce the chemical composition of the material.

21. The system of claim 14, wherein the environmental cost of the acquired character comprises an amount of environmental pollution resulting from producing the chemical composition of the material.

22. The system of claim 14, wherein the one or more programming instructions that, when executed, cause the processing device to determine an energy credit for the material comprise one or more programming instructions that, when executed, cause the processing device to subtract the acquired character energy score from the intrinsic energy score to provide the energy credit for the material.

23. The system of claim 14, wherein the one or more programming instructions further comprise one or more programming instructions that, when executed, cause the processing device to:
analyzing the material to provide a chemical composition of the material.

24. The system of claim 23, further comprising an input device in operable communication with the processing device, and wherein analyzing the material to provide a chemical composition comprises using the input device to determine the chemical composition of the material.

25. The system of claim 24, wherein the input device comprises one or more of the following: a combustion analysis device, a gas chromatograph, an elemental analyzer, a mass spectrometer, an infrared spectrometer, an ultraviolet spectrometer, a Raman spectrometer, a liquid chromatograph, and a nuclear resonance imager.

26. The system of claim 14, wherein the material is a virgin material.

27. The system of claim 14, wherein the material is a recycled material.
